(19) United States
(12) Patent Application Publication
(10) Pub. No.: US 2012/0211342 A1
(43) Pub. Date: Aug. 23, 2012

(54) Method of fabricating a keypad structure having an engraved pattern, keypad structure, and keypad semi-structure

(76) Inventor: Ko-Ju Chen, Taoyuan (TW)

(21) Appl. No.: 13/161,510

(22) Filed: Jun. 16, 2011

(30) Foreign Application Priority Data
Feb. 17, 2011 (TW) 100105216
Feb. 17, 2011 (TW) 100202878

(51) Int. Cl. H01H 13/76; B23P 17/00; H01H 13/02

(52) U.S. Cl. 200/5 A; 200/341; 29/592

(57) ABSTRACT

A method of fabricating a keypad structure having an engraved pattern, in which a keycap layer including a hard coating as a top layer is provided. The keycap layer is punched to form at least a keycap component utilized to assembly a keypad semi-product. The keypad semi-product is kept in a storage place. A pattern is provided. After a demand of the pattern is confirmed, the keypad semi-product is fetched and the hard coating is partially removed to form the confirmed pattern to complete a keypad structure. A keypad structure and a keypad semi-structure are also provided.

### BACKGROUND OF THE INVENTION

1. Field of the Invention

The present invention relates to a fabrication method of a keypad structure, and particularly to a fabrication method for a high wear-resisting keypad structure in which demanded patterns are formed after assembly, a keypad structure and a keypad semi-structure, to reduce for example product storage and excess material due to various language versions.

2. Description of the Prior Art

Electronic products such as telephones, cell phones, smart phones, personal digital assistants (PDAs), electronic translators and the like usually include keypad structures. FIG. 1 illustrates a schematic cross-sectional view of a conventional keycap structure of a keypad structure. A resin keycap body 4 of a keycap structure 2 usually includes a plurality of color layers, for example color layers 6 and 8. The color layer 8 is laser-etched (or referred to as laser-engraved) to form a hollowed pattern 10 to exposed a color of the underlying color layer 6. Thereafter, a transparent hard coating 12 is formed to cover the color layers 6 and 8 for protection. The such-formed keycap is combined with an electric circuit board, plungers, metal domes, and so on to form a keypad structure. In a conventional fabrication process, the laser etching for key legends is performed before formation of the hard coating layer and the assembly. However, patterns for the key legends are often different depending on demands, especially for the various language versions due to globalization. Accordingly, it is usual for a manufacturer to confirm the patterns of the key legends demanded by clients first and then to start the fabrication of the keypad. In addition, it is not easy to prepare material for fabrication in advance of the confirmation. Therefore, it often takes a long time to provide the products after receiving the order.

Japan Patent Application Publication No. 2007-213839 discloses a illumination type decorated molding and an illumination type key sheet, in which, a pattern is printed on surface of a keycap body, then a transparent protection layer is formed to cover the pattern, and thereafter the finished keycap structure is used in keypad assembly.

Japan Patent Application Publication No. 2006-190497 discloses a keycap structure, in which, a metal layer and a thin color layer are formed on the keycap body, and, the resultant patterns are covered with a transparent protection layer after the metal layer and the thin color layer are laser-etched, and thereafter the finished keycap structure is used in keypad assembly.

Japan Patent Application Publication No. 2004-202916 discloses a keycap structure, in which, three groups of bubbles or three groups of cracks are formed in a three-dimensional direction in the inside of the keycap body to form the display part three-dimensionally. Thereafter, the finished keycap structure is used in key button assembly.

Therefore, there is still a need for a novel method for fabricating keypads and a keypad structure to supply goods fast on demands.

### SUMMARY OF THE INVENTION

One objective of the present invention is to provide a method of fabricating a keypad structure, a keypad structure and a keypad semi-product. The keypad structure includes for example laser-etched patterns and is wear-resistant. With the present invention, an amount of product storage and excess material due to various demands or various language versions can be reduced.

According to an embodiment of the present invention, a method of fabricating a keypad structure having an engraved pattern is provided. The method includes steps as follows. A keycap layer is provided. The keycap layer includes a keycap body and a hard coating, and particularly the hard coating covers the keycap body to become the outmost layer of the keycap layer. The keycap layer is cut to form at least one first keycap component. The first keycap component is combined to be in a keypad semi-product. The keypad semi-product is placed in a storage place. A first pattern is provided. After a demand of the first pattern is confirmed, the keypad semi-product is fetched from the storage place to partially remove the hard coating of the keypad semi-product to form the first pattern to obtain the keypad structure.

According to another embodiment of the present invention, a keypad structure includes a circuit board, a metal dome disposed above the circuit board, a plunger disposed above the metal domes and a keycap structure disposed above the plunger. The keycap structure includes a keycap body and a hard coating. The hard coating covers the keycap body to become the outmost layer of the keycap structure. The hard coating is partially removed to form a first hollowed pattern to expose an underlying color.

According to further another embodiment of the present invention, a keypad semi-product includes a circuit board, a plurality of metal domes disposed above the circuit board, a plurality of plungers correspondingly disposed above the metal domes, and a plurality of keycap structures correspondingly disposed above the plungers. A first portion of the keycap structures each comprises a first pattern which is finished. A second portion of the keycap structures each includes a keycap body and a hard coating. The hard coating covers the keycap body to become the outmost layer of the keycap structures. The second portion of the keycap structures each have at least one area waiting for a second pattern to be formed thereon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view illustrating a conventional keycap structure;

FIG. 2 is a flow chart illustrating an embodiment of a method of fabricating a keypad structure having an engraved pattern according to the present invention;

FIG. 3 is a schematic cross-sectional view illustrating an embodiment of a keycap layer in the method of fabricating a keypad structure having an engraved pattern according to the present invention;

FIG. 4 is a schematic perspective diagram illustrating an embodiment of a keypad semi-product according to the present invention;

FIG. 5 is a schematic cross-sectional view taken along Line AA shown in FIG. 4;

FIG. 6 is a schematic cross-sectional view illustrating an embodiment of a keypad structure according to the present invention;

FIGS. 7 and 8 are schematic cross-sectional views illustrating some embodiments of a keypad structure according to the present invention; and

FIG. 9 is a schematic plan view illustrating an embodiment of a keypad structure according to the present invention.

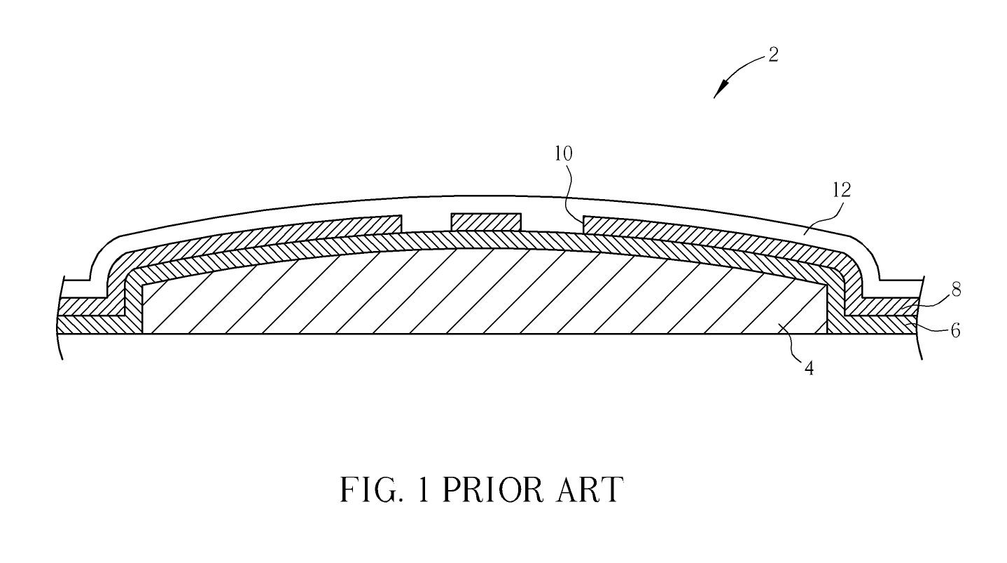

### DETAILED DESCRIPTION

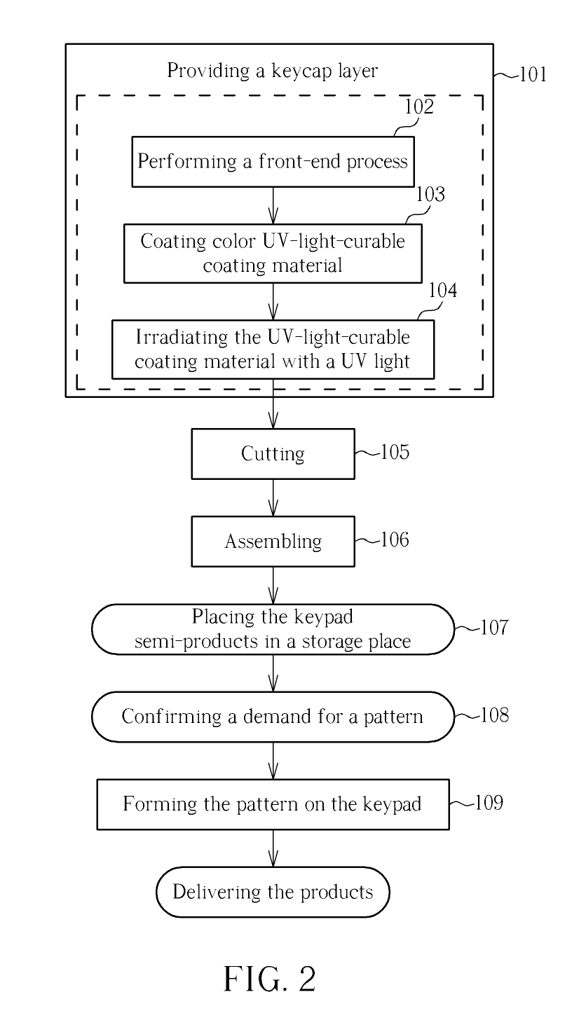

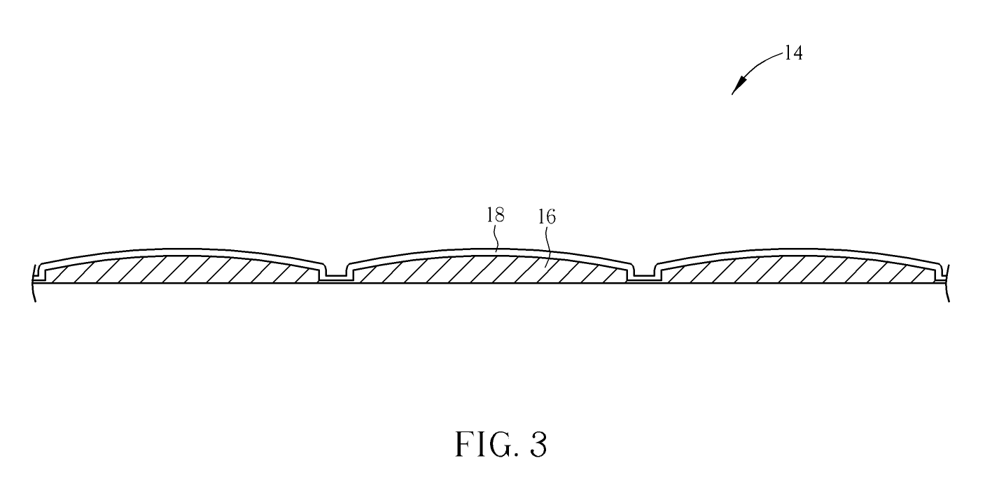

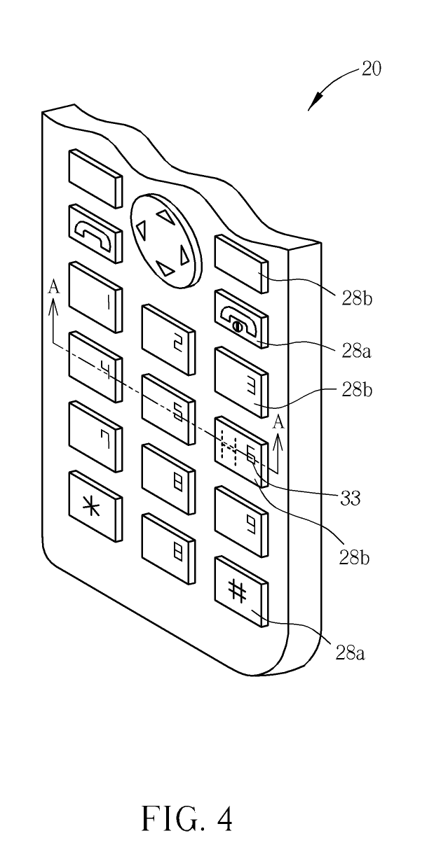

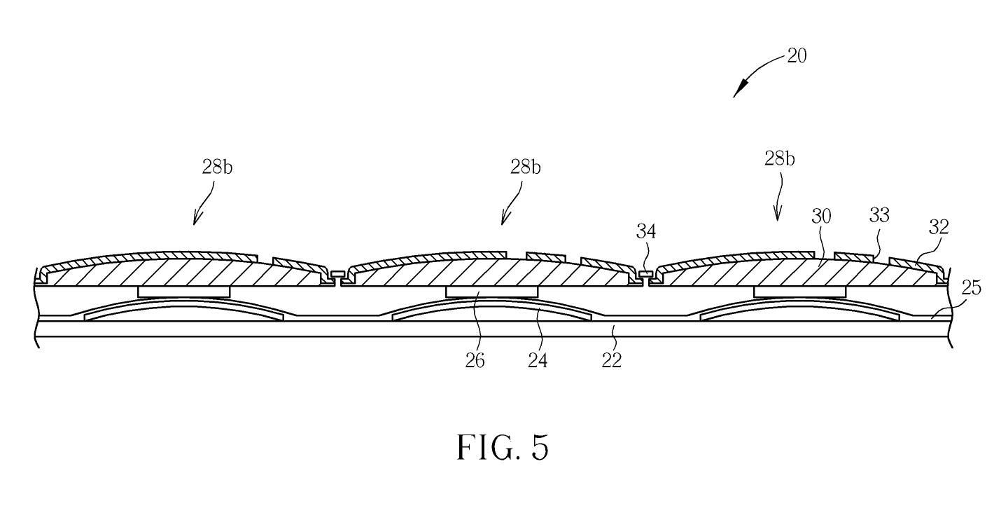

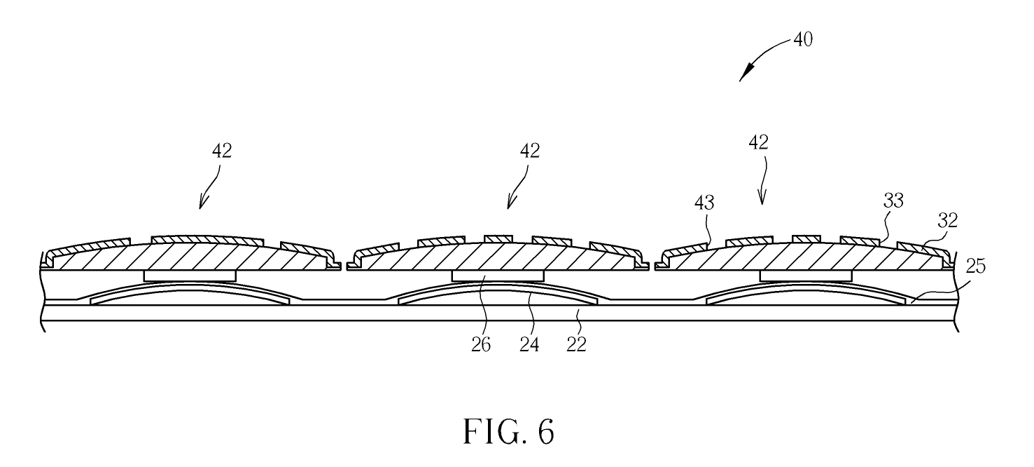

FIG. 2 is a flow chart illustrating an embodiment of a method of fabricating a keypad structure having an engraved pattern according to the present invention, and also please refer to a schematic cross-sectional view of a keycap layer in FIG. 3, an illustration of an embodiment of a keypad semi-product in FIGS. 4 and 5, and an illustration of an embodiment of a keypad structure in FIG. 6.

First, referring to FIG. 2, Step 101 is performed to provide a keycap layer. As shown in FIG. 3, a keycap layer 14 includes a keycap body 16 and a hard coating 18. The formation of the keycap layer is not particularly limited and can be made using a conventional method. For example, Steps 102, 103 and 104 are some embodiments to make keycap layers.

Step 102 is performed to carry out a front-end process. As an embodiment, a keycap body layer having one or more keycap shapes formed on a carrier or a keycap body layer having one keycap shape or a plurality of keycap shapes connected each other together formed of keycap body material per se by molding. Furthermore, for example, the molded keycap body layer may be coated with one or more color layers as desired and then coated with a transparent layer for protecting the color layers. Alternatively, for example, one face of a transparent carrier, which is also a transparent layer, may be covered with one or more color layers in a way, such as printing, spraying, brushing and the like. Thereafter, the transparent carrier with the color layers is pressed to form one or more recesses each in a keycap shape. The recesses are filled with keycap body material to form a keycap body layer. The color layer may be disposed between the transparent carrier and the keycap body material. Accordingly, the transparent carrier may protect the color layer. However, the color layer may be otherwise disposed on another side of the transparent carrier without particular limitation.

Thereafter, a step of forming a hard coating is performed. For example, Step 103 is performed to coat a colored UV-light-curable coating material on the keycap layer to become the topmost (also referred to as the outmost layer). Step 104 is performed to irradiate the UV-light-curable coating material with a UV light for curing to form a UV-light-cured coating for serving as a coating layer. A suitable heat-curable coating material may be also utilized to form a hard coating. The hard coating may be black, white, or other color, or not in color, and it is not limited thereto. Pigment or dye may be added in accordance with the properties of the coating material. The hard coating may be opaque, semi-transparent or transparent.

Thereafter, Step 105 of cutting is performed. The cutting also can be referred to as punching and is carried out to cut the keycap layer into a plurality of keycap components as designed or desired. In the present invention, the keycap component is not limited to a single keycap or a piece of keycap component having a plurality of keycaps. The type of keycap is not particularly limited. For example, the keycap component may be a thin-type keycap or a small-sized keycap as demanded for being tiny and light, or the keycap component may be formed by molding or glue-dispensing. Step 106 is performed to combine the keycap components within one or more keypad semi-products, as shown in FIGS. 4 and 5.

Thereafter, Step 107 is performed to place the keypad semi-products in a storage place. They may be stored until being fetched out for completion of the products on demand.

When a keypad structure is demanded, Step 108 is performed to provide one or more patterns. The pattern may be for example customized for showing letters, characters, numbers, symbols, figures, and the like. After the demand of the patterns is confirmed by clients, the keypad semi-products are fetched out from the storage place for performing Step 109 to partially remove (for example, laser-etch) the hard coating of one or more keypad semi-products to form the confirmed pattern to obtain one or more keypad structure products for delivery.

Moreover, before the keypad semi-products are stored in the storage place, at least one keycap may be in advance formed with a pattern during the fabrication process. Furthermore, the keypad semi-products may be assembled with other keycap components which have already had patterns in common for other products. The patterns are formed in advance on the keycaps in a conventional way. Accordingly, after the demanded patterns are confirmed by clients, the time needed for finishing the keypad structures can be reduced.

FIGS. 4 and 5 are schematic diagrams illustrating an embodiment of a keypad semi-product according to the present invention. The keypad semi-product 20 includes a circuit board 22, a plurality of metal domes 24 disposed above the circuit board 22, a plurality of plungers 26 disposed above the metal domes 24 and a plurality of keycap structures disposed above the plungers 26 correspondingly. A dome sheet 25 may be further included to cover the metal dome 24 and secure the metal domes 24 on the circuit board 22. A portion 28a of the keycap structures each include completed patterns. Another portion 28b of keycap structures each include a keycap body 30 and a hard coating 32 covering the keycap body 30 to become the outmost layer of the keycap structures. A shielding layer 34 may be further formed among the keycap structures. The hard coating may have a color. Such another portion 28b of the keycap structures each have an area without a pattern formed thereon, and the areas wait for formation of the patterns confirmed by clients.

As shown in FIGS. 4 and 5, the keycap structures 28b also may further include completed common patterns. The common patterns are the same as those of other products. The common pattern 33 (hollowed pattern) may be formed in advance by for example laser etching.

FIG. 6 is a schematic cross-sectional view illustrating an embodiment of a keypad structure according to the present invention. As compared with the structure shown in FIGS. 4 and 5, the pattern 43 (hallowed pattern), which is the pattern being confirmed, on the hard coating of each keypad structure 42 of the keypad panel 40 in the embodiment has been formed, and the keypad panel 40 is a finished product. The keypad structure 42 includes a structure as the keycap structure 28b and the hard coating is partially removed to form a hollowed pattern to expose an underlying color. The keycap structure formed in this way has the color matching of the keycap body layer with the hard coating.

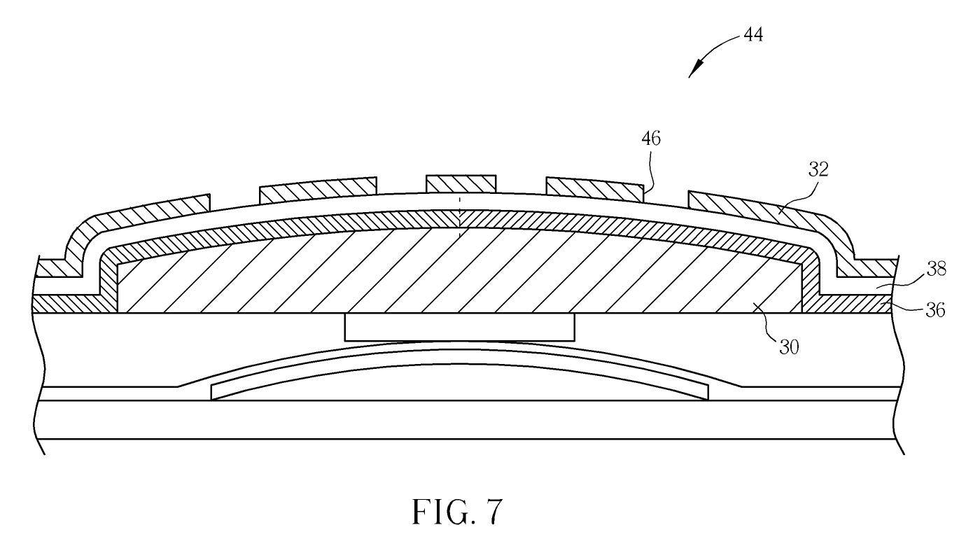

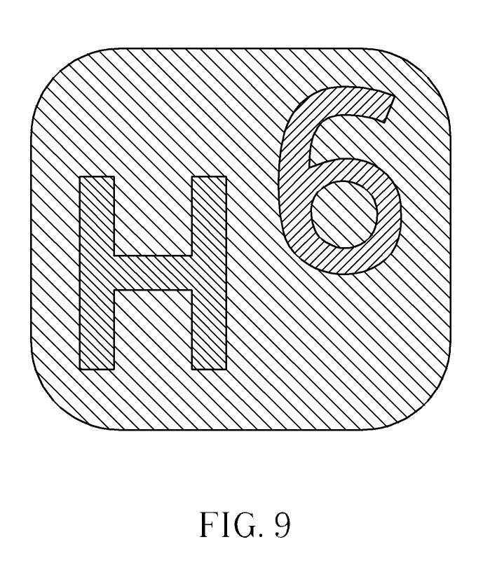

Furthermore, the color matching may be various. For example, a color layer may be formed between the keycap body and the hard coating. The color of the color layer may be exposed through the hollowed pattern of the hard coating. In other embodiment, the keypad structure 44 as shown in FIG. 7 may further include a transparent layer 38 between the color layer 36 and the hard coating 32. The transparent layer 38 may protect the color layer 36, or serve as the carrier for forming the keycap body in injection molding process. The color of the color layer 36 can be still exposed through the hollowed pattern 46 of the hard coating 32. The keycap structure formed in this way has the color matching of the color layer with the hard coating. The color layer 36 may further have two or more colors. For example, two sides of the dot line shown in FIG. 7 have different colors, such that the pattern is colorful and beautiful. As shown in the plan view of FIG. 9, the letter “H” and the number “9” may be in different colors, and the hard coating is, for example, black.

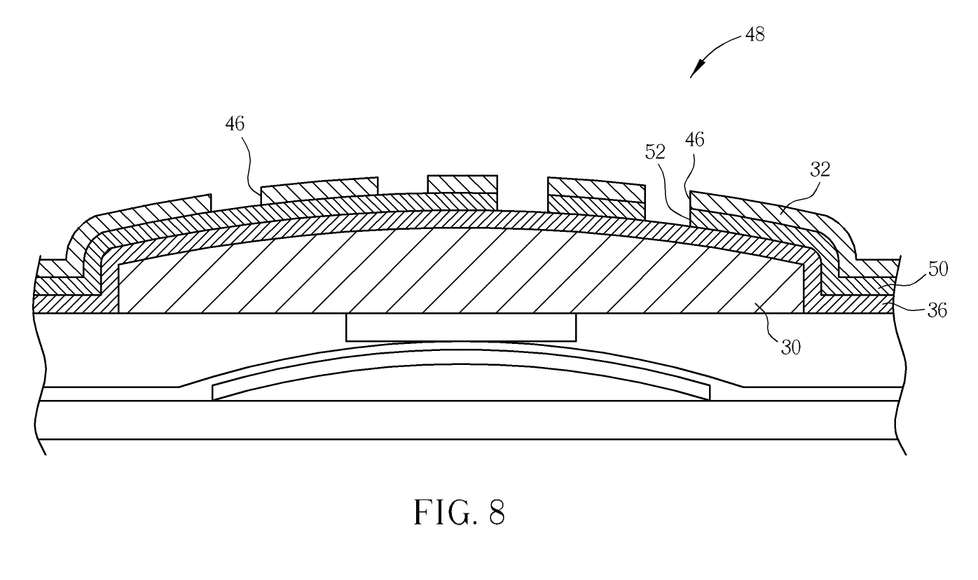

In one embodiment, as shown in FIG. 8, in a keypad structure 48, a color layer 50 is between the keycap body 30 and a hard coating 32. The color of the color layer 50 is exposed through the hallowed pattern 46 of the hard coating 32. The color layer 50 further has a hollowed pattern 52 at a position located correspondingly to apart of the hallowed pattern 46, i.e. the hollowed pattern 52 overlaps a part of the hallowed pattern 46. The color layer 36 is disposed between the color layer 50 and the keycap body 30. The color of the color layer 36 is thus exposed through the hallowed pattern 46 and the hollowed pattern 52, to achieve double color effect and beauty. This is also the situation as shown in FIG. 9. Furthermore, a transparent layer (not shown) may be further disposed between the color layer 50 and the hard coating 32, to protect the color layer 50 and the color layer 36 or to serve as a carrier for the molded keycap body 30. In the present invention, the number of layers for the color layers is not particularly limited, as long as the product requirement can be followed.

In the present invention, in order to reduce product storage and excess material due to various language versions, a keypad semi-product is formed with certain keycap components in advance, in which some certain or common patterns are formed, and some areas of the keycaps are blank to wait for formation of patterns after the confirmation. In such way, a batch of keypad semi-products can be produced and placed in a storage place before the confirmation of the pattern versions or the language versions. After the confirmation is made, the keypad semi-products are taken out for simply further forming the confirmed patterns by for example laser etching, and accordingly the products can be accomplished in a short time and delivered. In such way, the products can be rapidly provided with various versions of patterns, especially with respect to various countries and still can meet test requirements. The outmost layer of the keycap is the hard coating in color and preferably includes a wear-resistant material, and therefore a laser etching process (or other process) may be performed on the hard coating, as soon as the pattern is confirmed, to expose an underlying color to serve as a desired pattern. The keypad structure can be rapidly completed.

Those skilled in the art will readily observe that numerous modifications and alterations of the device and method may be made while retaining the teachings of the invention.

What is claimed is:

1. A method of fabricating a keypad structure having an engraved pattern, comprising:
providing a keycap layer comprising a keycap body and a hard coating covering the keycap body to become an outmost layer of the keycap layer;
cutting the keycap layer to form at least one first keycap component; combining the first keycap component into a keypad semi-product; placing the keypad semi-product in a storage place;
providing a first pattern; and
after a demand of the first pattern being confirmed, fetching the keypad semi-product from the storage place to partially remove the hard coating of the keypad semi-product to form the first pattern to obtain the keypad structure.

2. The method according to claim 1, wherein a second pattern is formed on the first keycap component before the keypad semi-product is placed in the storage place.

3. The method according to claim 1, further comprising:
providing at least one second keycap component; and
combining the second keycap component into the keypad semi-product, wherein a third pattern is formed on the second keycap component before the keypad semi-product is placed in the storage place.

4. The method according to claim 1, wherein the hard coating comprises a UV light-cured hard coating.

5. The method according to claim 1, wherein the keycap layer further comprises a first color layer disposed between the keycap body and the hard coating.

6. The method according to claim 5, wherein the keycap layer further comprises a transparent layer between the first color layer and the hard coating for protecting the first color layer.

7. The method according to claim 5, wherein, the keycap layer further comprises a second color layer between the first color layer and the keycap body, and after partially removing the hard coating of the keypad semi-product, the method further comprises partially removing the first cooler layer to form the first pattern to finish the keypad structure.

8. A keypad structure comprising:
a circuit board;
a metal dome disposed above the circuit board;
a plunger disposed above the metal domes; and
a keycap structure disposed above the plunger, the keycap structure comprising:
a keycap body, and
a hard coating covering the keycap body to become an outmost layer of the keycap structure, wherein the hard coating is partially removed to form a first hollowed pattern to expose an underlying color.

9. The keypad structure according to claim 8, wherein, the keycap structure further comprises a first color layer disposed between the keycap body and the hard coating, and the first color layer is exposed through the first hallowed pattern of the hard coating to show the underlying color.

10. The keypad structure according to claim 9, wherein the keycap structure further comprises a transparent layer between the first color layer and the hard coating.

11. The keypad structure according to claim 8, wherein the keycap structure further comprises:
a first color layer disposed between the keycap body and the hard coating, and the first color layer is exposed through the first hallowed pattern of the hard coating to show the underlying color, and the first color layer has a second hollowed pattern located correspondingly to a part of the first hallowed pattern; and
a second color layer disposed between the first color layer and the keycap body, wherein a color of the second color layer is exposed through the first hallowed pattern and the second hollowed pattern.

12. The keypad structure according to claim 11, wherein the keycap structure further comprises a transparent layer disposed between the first color layer and the hard coating.

13. The keypad structure according to claim 8, wherein the hard coating comprises a UV light-cured hard coating.

14. A keypad semi-product comprising:
a circuit board;
a plurality of metal domes disposed above the circuit board;
a plurality of plungers correspondingly disposed above the metal domes; and
a plurality of keycap structures correspondingly disposed above the plungers, wherein,
a first portion of the keycap structures each comprise a first pattern which is finished, and
a second portion of the keycap structures each comprise:
a keycap body, and
a hard coating covering the keycap body to become an outmost layer of the keycap structures, wherein the second portion of the keycap structures each have at least one area waiting for a second pattern to be formed thereon.

15. The keypad semi-product according to claim 14, wherein the second portion of the keycap structures each further comprise a transparent layer between the keycap body and the hard coating.

16. The keypad semi-product according to claim 15, wherein the second portion of the keycap structures each further comprise a transparent layer between the at least one first color layer and the hard coating.

17. The keypad semi-product according to claim 14, wherein the hard coating comprises a UV light-cured hard coating.
